(19) United States
(12) Patent Application Publication
(10) Pub. No.: US 2026/0029032 A1
(43) Pub. Date: Jan. 29, 2026

(54) WET FRICTION MATERIAL INCLUDING ARC SHAPED SEGMENTS OF DIFFERENT MATERIALS

(71) Applicant: Schaeffler Technologies AG & Co. KG, Herzogenaurach (DE)

(72) Inventors: Michael Yanetta, Wadsworth, OH (US); Murat Bakan, Canton, OH (US); Rashid Farahati, Copley, OH (US)

(21) Appl. No.: 18/784,842

(22) Filed: Jul. 25, 2024

(51) Int. Cl. F16D 69/02

(52) U.S. Cl. CPC F16D 69/026; F16D 2200/006

(57) ABSTRACT

A wet friction assembly includes a part; and at least one first arc shaped wet friction material segment and at least one second arc shaped wet friction material segment to the part to form an annular wet friction material layer on the part. Each first arc shaped wet friction material segment has a first composition including a binder, fibers and filler particles. Each second arc shaped wet friction material segment has a second composition including a binder, fibers and filler particles. The first composition is different from the second composition.

The present disclosure relates generally to friction clutches and plates used in torque converters and motor vehicle transmissions and more specifically to wet friction material.

### BACKGROUND

The friction material in wet-type friction clutches generally operates in an oil submerged environment and is often paper-based material used to form friction material rings. It is known to combine fibers and filler particles and then saturate them with a resin.

### SUMMARY OF THE INVENTION

A wet friction assembly includes a part; and at least one first arc shaped wet friction material segment and at least one second arc shaped wet friction material segment to the part to form an annular wet friction material layer on the part. Each first arc shaped wet friction material segment has a first composition including a binder, fibers and filler particles. Each second arc shaped wet friction material segment has a second composition including a binder, fibers and filler particles. The first composition is different from the second composition.

In examples, the first composition includes a first fiber composition of the fibers and the second composition includes a second fiber composition of the fibers, the first fiber composition being different from the second fiber composition.

In examples, the first fiber composition includes a first composition of aramid fibers and a first composition of cellulose fibers, wherein the second fiber composition includes a second composition of aramid fibers and a second composition of cellulose fibers, the first composition of aramid fibers being less than the second composition of aramid fibers.

In examples, the first fiber composition includes a first composition of aramid fibers and a first composition of cellulose fibers, wherein the second fiber composition includes a second composition of aramid fibers and a second composition of cellulose fibers, the first composition of cellulose fibers being greater than the second composition of cellulose fibers.

In examples, the first fiber composition includes a first composition of aramid fibers and a first composition of cellulose fibers, wherein the second fiber composition includes a second composition of aramid fibers and a second composition of cellulose fibers, the first composition of aramid fibers being less than the second composition of aramid fibers, the first composition of cellulose fibers being greater than the second composition of cellulose fibers.

In examples, the first composition, by weight percentage, includes 3 to 14% aramid fibers, 25 to 43% cellulose fibers, 13 to 32% filler particles and 30 to 40% binder, wherein the second composition, by weight percentage, includes 25 to 43% aramid fibers, 3 to 14% cellulose fibers and 13 to 32% filler particles.

In examples, each of the at least one first arc shaped wet friction material segments and each of the at least one second arc shaped wet friction material segments has: a first axially facing surface configured as a friction contacting surface configured for being brought in and out of contact with a further surface for frictional engagement with the further surface, a first edge extending radially and facing circumferentially in a first direction, a second edge extending radially and facing circumferentially in a second direction, a third edge extending circumferentially from the first edge to the second edge and defining an inner circumference of the respective first or second arc shaped wet friction material segment, and a fourth edge extending circumferentially from the first edge to the second edge and defining an outer circumference of the respective first or second arc shaped wet friction material segment; each of the first, second, third and fourth edges joining the first axially facing surface of the respective first or second arc shaped wet friction material segment.

In examples, each of the at least one first arc shaped wet friction material segments and each of the at least one second arc shaped wet friction material segments has: a second axially facing surface opposite of the first axially facing surface joined to the part, each of the first, second, third and fourth edges joining the second axially facing surface of the respective first or second arc shaped wet friction material segment

In examples, each of the at least one first arc shaped wet friction material segments defines a first angular range of between 10 and 180 degrees between the respective first edge and the respective second edge, and each of the at least one second arc shaped wet friction material segments defines a second angular range between 10 and 180 degrees between the respective first edge and the respective second edge.

In examples, the first edge of the least one first arc shaped wet friction material segment contacts the second edge of the least one second arc shaped wet friction material segment.

In examples, the first edge of the least one first arc shaped wet friction material segment is circumferentially spaced apart from the second edge of the least one second arc shaped wet friction material segment such that the first edge of the least one first arc shaped wet friction material segment is spaced apart from and directly faces the second edge of the least one first arc shaped wet friction material segment.

In examples, the at least one first arc shaped wet friction material segment is at least two first arc shaped wet friction material segments and the at least one second arc shaped wet friction material segment is at least two second arc shaped wet friction material segments, the first edge of each of the least two first arc shaped wet friction material segment contacts the second edge of one of the at least two second arc shaped wet friction material segments, and the second edge of each of the least two first arc shaped wet friction material segment contacts the first edge of one of the at least two second arc shaped wet friction material segments.

In examples, the at least one first arc shaped wet friction material segment is at least two first arc shaped wet friction material segments and the at least one second arc shaped wet friction material segment is at least two second arc shaped wet friction material segments, the first edge of each of the least two first arc shaped wet friction material segments is circumferentially spaced apart from the second edge of one of the at least two second arc shaped wet friction material segments such that the first edge of each the least two first arc shaped wet friction material segments is spaced apart from and directly faces the second edge of one of the at least two second arc shaped wet friction material segments, and the second edge of each of the least two first arc shaped wet friction material segments is circumferentially spaced apart from the first edge of one of the at least two second arc shaped wet friction material segments such that the second edge of each the least two first arc shaped wet friction material segments is spaced apart from and directly faces the first edge of one of the at least two second arc shaped wet friction material segments.

A method of making a wet friction assembly is also provided that includes fixing at least one first arc shaped wet friction material segment and at least one second arc shaped wet friction material segment to a part to form an annular wet friction material layer on the part. Each first arc shaped wet friction material segment has a first composition including a binder, fibers and filler particles. Each second arc shaped wet friction material segment has a second composition including a binder, fibers and filler particles. The first composition is different from the second composition.

### BRIEF DESCRIPTION OF THE DRAWINGS

The present disclosure is described below by reference to the following drawings, in which:

FIG. 1a schematically shows a side view of wet friction material layers before the binder is added;

FIG. 1b schematically shows a side view of wet friction material layers after the binder is added;

FIG. 1c schematically shows a top plan view of the wet friction material layers after the wet friction material layers are cut into arc shaped segments;

FIG. 1d schematically shows a side view of the wet friction material arc shaped segments being joined to a clutch part;

FIG. 1e schematically shows a top plan view of the wet friction material arc shaped segments joined to the clutch part to form an annular wet friction material layer on the clutch part; and

FIG. 2 shows annular wet friction material layer bonded to both sides of a metal part in the form of a clutch plate of lockup clutch assembly of a torque converter.

### DETAILED DESCRIPTION

The present disclosure provides a method that includes mounting two different friction materials circumferentially adjacent to each to form a dual-material friction surface. Both friction materials can thus contact an opposing surface together to provide an improved friction performance. Specifically, the wet friction material of the present disclosure can be beneficial in hybrid and e-mobility applications targeting high energy/power applications without sacrificing from the material performance. The higher power and energy requirements result in higher engagement temperatures. The wet friction material of the present disclosure can endure the higher temperatures, power, and energy densities.

A clutch facing combining different wet friction materials thus is provided that can be use to gain advantages in the friction performance. A material with a friction performance above a predetermined threshold, but with durability below a predetermined threshold, can be combined with a material that has durability above a predetermined threshold, but with a friction performance below a predetermined threshold, and the resulting facing can gain in friction performance and also increase the durability of the clutch. Ratios of each material can be balanced to get the desired friction performance and durability properties.

For example, durability can be measured using a SAE J2488 test and durability can be measured by a friction material wear, coefficient of friction change, and material glazing.

For example, friction performance can be measured using a standard test GMN10055b and can be determined by coefficient value and gradient.

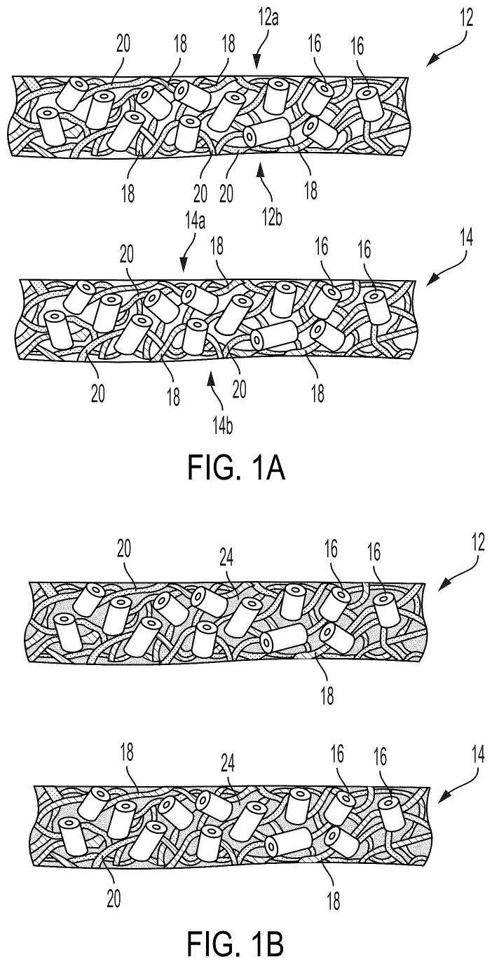

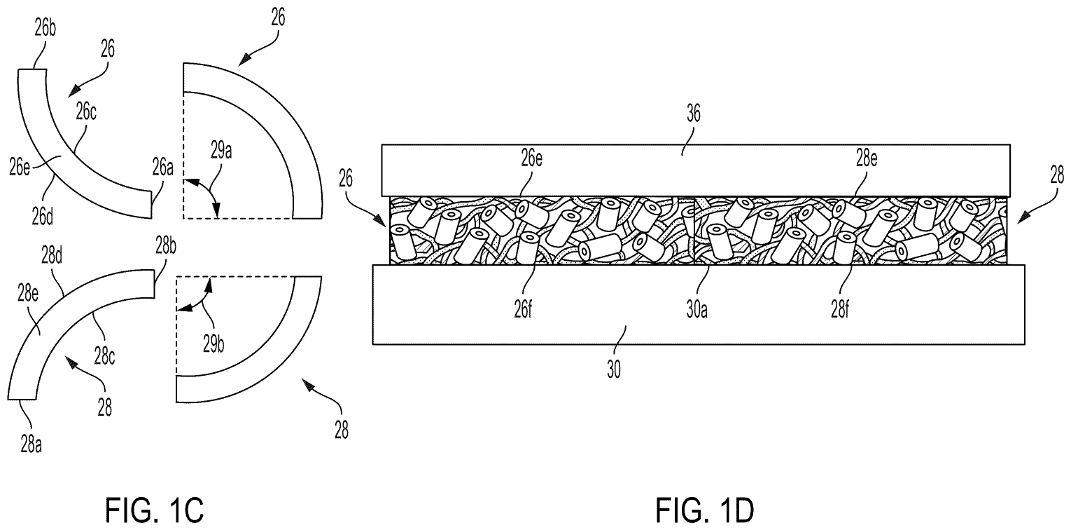

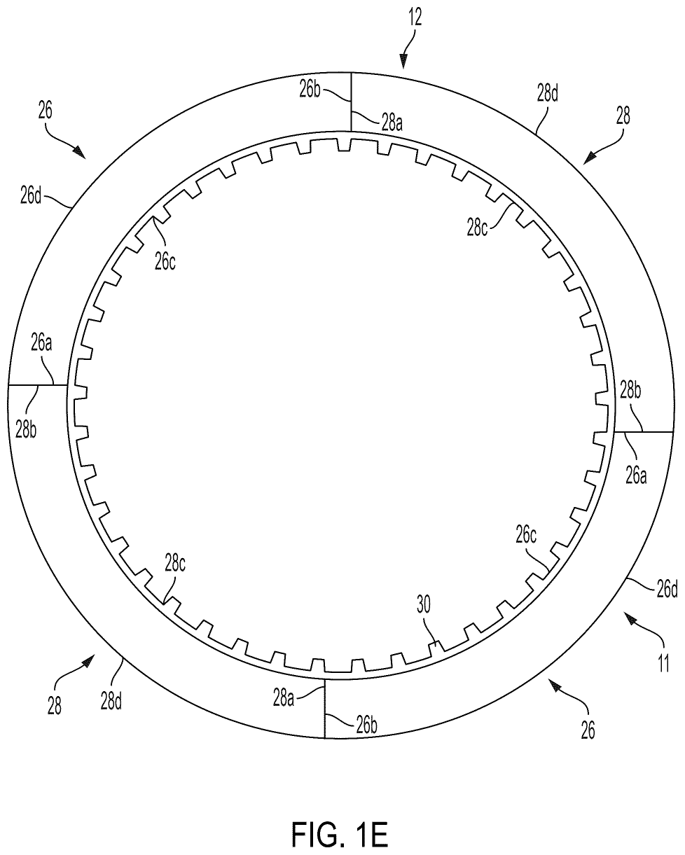

FIGS. 1a to 1e schematically illustrate a method of making an annular wet friction material 10 and a clutch assembly 11 in accordance with an embodiment of the present disclosure.

At least two different wet friction material layers are prepared, including a first friction material layer 12 including a first composition and having a first durability and a first friction performance and a second friction material layer 14 including a second composition and having a second durability and a second friction performance.

Each wet friction material layer 12, 14 may be formed of fibers, filler material and a binder. The fibers may be aramid fibers, organic fibers, carbon fibers and/or fiberglass. The organic fibers may include cellulose fibers or cotton fibers. The filler particles may be diatomaceous earth. The binder may be a phenolic resin. Optionally a friction modifier such as graphite may also be included in layer 12 and/or layer 14.

FIG. 1a schematically shows layers 12 and 14 before the binder, in liquid form, is added. Layer 12 includes a material base formed by a plurality of diatomaceous earth particles 16 embedded in a matrix of aramid fibers 18 and cellulose fibers 20 between a first outer surface 12a and a second outer surface 12b of layer 12. Layer 14 also includes a material base formed by a plurality of diatomaceous earth particles 16 embedded in a matrix of aramid fibers 18 and cellulose fibers 20 between a first outer surface 14a and a second outer surface 14b of layer 14. Layer 12 includes a greater percentage weight of cellulose fibers 20 than layer 14, and layer 14 including a greater percentage weight of aramid fibers 18 than layer 12.

Fibers 18, 20, particles 16 and any friction modifiers are joined together in a pulping process, which involves forming a mixture of the fibers 18, 20, particles 16 and any friction modifiers submerged together in a liquid solution, then drying the mixture to remove the liquid. After fibers 18, 20 and particles 16 are joined together by the liquid solution and dried, layers 12, 14 each include a matrix formed by fibers 18, 20 and filler particles 16 that define a network of voids 22.

As shown in FIG. 1b, after fibers 18, 20 and particles 16 are joined together, a binder 24 is added to each of layers 12, 14 such that voids 22 (FIG. 1a) in layers 12, 14 between a matrix formed by 18, 20 and particles 16 are saturated with the binder 24. The layers 12, 14 can each be dipped in the binder, which can be phenolic resin, and squeezed through a stainless steel roller to remove excess binder. After excess binder is removed, the binder is subject to a first curing, which can be a B-stage curing, where the layers 12, 14 are hardened but remain a level of flexibility.

In some preferred embodiments, prior to binder being added, layer 12 can include, by weight percentage, 5 to 20% aramid fibers, 40 to 60% cellulose fibers and 20 to 45% filler particles, and layer 14 can include, by weight percentage, 40 to 60% aramid fibers, 5 to 20% cellulose fibers and 20 to 45% filler particles. The filler particles of both layers 12, 14 can be diatomaceous earth. The binder is added on in weight percent that is 30-40% of the weight of the resulting friction material. Thus, after the first curing, layer 12can include, by weight percentage, 3 to 14% aramid fibers, 25 to 43% cellulose fibers, 13 to 32% filler particles and 30 to 40% binder, and layer 14 can include, by weight percentage, 25 to 43% aramid fibers, 3 to 14% cellulose fibers and 13 to 32% filler particles.

As shown in FIG. 1c, after adding binder 24 and performing the first curing, layers 12, 14 can be cut into arc shaped segments 26, 28. Each of arc shaped segments 26 has a first edge 26a extending radially and facing circumferentially in a first direction, a second edge 26b extending radially and facing circumferentially in a second direction, a third edge 26c extending circumferentially from edge 26a to edge 26b and defining an inner circumference of segment 26, and a fourth edge 26d extending circumferentially from edge 26a to edge 26b and defining an outer circumference of segment 26. Edges 26a to 26d each extend from a first axially facing surface 26e, which is configured as a friction contacting surface configured for being brought in and out of contact with further surface for frictional engagement with the further, to a second axially facing surface 26f, which is configured for being joined in a fixed manner to a surface of a further part.

Similarly, each of arc shaped segments 28 has a first edge 28a extending radially and facing circumferentially in a first direction, a second edge 28b extending radially and facing circumferentially in a second direction, a third edge 28c extending circumferentially from edge 28a to edge 28b and defining an inner circumference of segment 28, and a fourth edge 28d extending circumferentially from edge 28a to edge 28b and defining an outer circumference of segment 28. Edges 28a to 28d each extend from a first axially facing surface 28e, which is configured as a friction contacting surface configured for being brought in and out of contact with further surface for frictional engagement with the further, to a second axially facing surface 28f, which is configured for being joined in a fixed manner to a surface of a further part.

Each of the arc shaped segments 26 defines an angular range 29a between 10 and 180 degrees between the first edge 26a and the second edge 26b and each of the arc shaped segments 28 defines an angular range 29b between 10 and 180 degrees between the first edge 28a and the second edge 28b. In some embodiments, angular ranges 29a, 29b each have a same value of approximately (−/+5%) 360 divided by an integer. In other angular range 29a has a different value than angular range 29b. In the example in FIG. 1c, angular ranges 29a, 29b have a same value of 90 degrees.

As shown in FIGS. 1d, 1e, the arc shaped segments 26, 28 are then placed on top of a metal part 30 to form an annular wet friction material layer 10 and arc shaped segments 26, 28 are fixed to part 30 to form a friction assembly 34 including annular wet friction material layer 10. In the example in FIGS. 1d, 1e, as each of the arc shaped segments 26, 28 has a same angular range 30 of 90 degrees, two of arc shaped segments 26 are placed on a top of metal part 30 and two of arc shaped segments 28 are placed on top of metal part 30 and segments 26, 28. Because all four of segments 26, 28 each have a range of 90 degrees, the first edge 26a of each segment 26 contacts the second edge 28b of one of segments 28, and the second edge 26b of each segment 26 contacts the first edge 28a of one of segments 28, segments 26, 28 together have a range of 360 degrees and form a continuous ring on part 30.

In other examples, segments 26, 28 can be circumferentially spaced apart from each other by gaps having an angular range between 0 and 5 degrees, such that the first radially extending edge 26a of each segment 26 is spaced apart from and directly faces the second radially extending edge 28b of one of segments 28, and the second radially extending edge 26b of each segment 26 is spaced apart from and directly faces the first radially extending edge 28a of one of segments 28. Segments 26, 28 thus together form a segmented ring.

As noted above, prior to joining of the arc shaped segments 26, 28 and part 30, the binder can be subject to an initial B-stage curing, where the layers 12, 14 are somewhat flexible. The joining of segments 26, 28 and part 30 together includes pressing segments 26, 28 against metal part 30 with a heat plate 32 to complete curing of the binder 24 in segments 26, 28, fixing segments 26, 28 and metal part 30 together to form annular wet friction material layer 10 on metal part 30. The force of pressing of heat plate 32 against outer surfaces 26e, 28e of segments 26, 28, while outer surfaces 26f, 28f of segments 26, 28 rest on an outer surface 30a of metal part 30, causes the binder to accumulate at an interface of outer surfaces 26f, 28f of segments 26, 28 and outer surface 30a of metal part 30, while the curing of the binder by the heat of heat plate 36 creates a permanent connection between metal part 30 and segments 26, 28. In one preferred embodiment, the heat at a surface 32a of plate 32 that contacts outer surface 12a of outer layer is 375 to 425 degrees F.

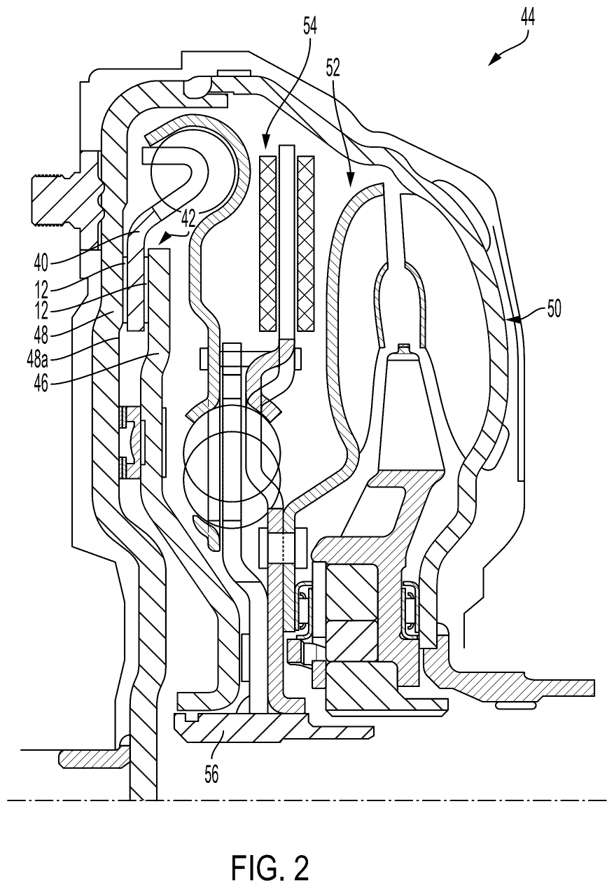

FIG. 2 shows annular wet friction material layer 10 bonded to both sides of a metal part in the form of a clutch plate 40 of lockup clutch assembly 42 of a torque converter 44. A piston 46 of lockup clutch assembly 42 forces clutch plate 40 against an inside surface 48a of a front cover 48 of torque converter 44. Piston 46 contacts the surfaces 26e, 28e of the rear wet friction material layer 10 to force the surfaces 26e, 28e on the front wet friction material layer 10 against inside surface 48a of front cover 48. The forcing of clutch plate 40 against front cover 48 by piston 46 locks the lockup clutch assembly 42 such that a torque path in torque converter 44 to a transmission input shaft bypasses an impeller 50 and a turbine 52 of torque converter 44, and instead flows from front cover 48 to clutch plate 40 and through a damper assembly 54 to a transmission input shaft that is connected to an output hub 56 of torque converter 44.

In the preceding specification, the disclosure has been described with reference to specific exemplary embodiments and examples thereof. It will, however, be evident that various modifications and changes may be made thereto without departing from the broader spirit and scope of disclosure as set forth in the claims that follow. The specification and drawings are accordingly to be regarded in an illustrative manner rather than a restrictive sense.

### LIST OF REFERENCE NUMERALS

10 annular wet friction material layer
11 clutch assembly
12 layers
14 layers
14a first outer surface
14b second outer surface
16 particles
18 fibers
20 fibers
22 voids
24 binder
26 segments
26a first edge
26b second edge
26c third edge
26d fourth edge
26e surfaces
26f outer surfaces
28 segments
28a first edge
28b second edge
28c third edge
28d fourth edge
28e surfaces
28f outer surfaces
29a angular ranges
29b angular range
30 metal part
30a outer surface
32 plate
32a surface
34 friction assembly
40 clutch plate
42 lockup clutch assembly
44 torque converter
46 piston
48 front cover
48a inside surface
50 impeller
52 turbine
54 damper assembly
56 output hub

What is claimed is:

1. A wet friction assembly comprising:
a part; and
at least one first arc shaped wet friction material segment and at least one second arc shaped wet friction material segment to the part to form an annular wet friction material layer on the part,
each first arc shaped wet friction material segment having a first composition including a binder, fibers and filler particles,
each second arc shaped wet friction material segment having a second composition including a binder, fibers and filler particles,
the first composition being different from the second composition.

2. The wet friction assembly as recited in claim 1 wherein the first composition includes a first fiber composition of the fibers and the second composition includes a second fiber composition of the fibers, the first fiber composition being different from the second fiber composition.

3. The wet friction assembly as recited in claim 2 wherein the first fiber composition includes a first composition of aramid fibers and a first composition of cellulose fibers,
wherein the second fiber composition includes a second composition of aramid fibers and a second composition of cellulose fibers,
the first composition of aramid fibers being less than the second composition of aramid fibers.

4. The wet friction assembly as recited in claim 2 wherein the first fiber composition includes a first composition of aramid fibers and a first composition of cellulose fibers,
wherein the second fiber composition includes a second composition of aramid fibers and a second composition of cellulose fibers,
the first composition of cellulose fibers being greater than the second composition of cellulose fibers.

5. The wet friction assembly as recited in claim 2 wherein the first fiber composition includes a first composition of aramid fibers and a first composition of cellulose fibers,
wherein the second fiber composition includes a second composition of aramid fibers and a second composition of cellulose fibers,
the first composition of aramid fibers being less than the second composition of aramid fibers,
the first composition of cellulose fibers being greater than the second composition of cellulose fibers.

6. The wet friction assembly as recited in claim 5 wherein the first composition, by weight percentage, includes 3 to 14% aramid fibers, 25 to 43% cellulose fibers, 13 to 32% filler particles and 30 to 40% binder,
wherein the second composition, by weight percentage, includes 25 to 43% aramid fibers, 3 to 14% cellulose fibers and 13 to 32% filler particles.

7. The wet friction assembly as recited in claim 1 wherein each of the at least one first arc shaped wet friction material segments and each of the at least one second arc shaped wet friction material segments has:
a first axially facing surface configured as a friction contacting surface configured for being brought in and out of contact with a further surface for frictional engagement with the further surface,
a first edge extending radially and facing circumferentially in a first direction,
a second edge extending radially and facing circumferentially in a second direction,
a third edge extending circumferentially from the first edge to the second edge and defining an inner circumference of the respective first or second arc shaped wet friction material segment, and
a fourth edge extending circumferentially from the first edge to the second edge and defining an outer circumference of the respective first or second arc shaped wet friction material segment;
each of the first, second, third and fourth edges joining the first axially facing surface of the respective first or second arc shaped wet friction material segment.

8. The wet friction assembly as recited in claim 7 wherein each of the at least one first arc shaped wet friction material segments and each of the at least one second arc shaped wet friction material segments has:
a second axially facing surface opposite of the first axially facing surface joined to the part,
each of the first, second, third and fourth edges joining the second axially facing surface of the respective first or second arc shaped wet friction material segment

9. The wet friction assembly as recited in claim 7 wherein each of the at least one first arc shaped wet friction material segments defines a first angular range of between 10 and 180 degrees between the respective first edge and the respective second edge, and each of the at least one second arc shaped wet friction material segments defines a second angular range between 10 and 180 degrees between the respective first edge and the respective second edge.

10. The wet friction assembly as recited in claim 9 wherein the first edge of the least one first arc shaped wet friction material segment contacts the second edge of the least one second arc shaped wet friction material segment.

11. The wet friction assembly as recited in claim 9 wherein the first edge of the least one first arc shaped wet friction material segment is circumferentially spaced apart from the second edge of the least one second arc shaped wet friction material segment such that the first edge of the least one first arc shaped wet friction material segment is spaced apart from and directly faces the second edge of the least one first arc shaped wet friction material segment.

12. The wet friction assembly as recited in claim 7 wherein the at least one first arc shaped wet friction material segment is at least two first arc shaped wet friction material segments and the at least one second arc shaped wet friction material segment is at least two second arc shaped wet friction material segments,
the first edge of each of the least two first arc shaped wet friction material segment contacts the second edge of one of the at least two second arc shaped wet friction material segments, and
the second edge of each of the least two first arc shaped wet friction material segment contacts the first edge of one of the at least two second arc shaped wet friction material segments.

13. The wet friction assembly as recited in claim 7 wherein the at least one first arc shaped wet friction material segment is at least two first arc shaped wet friction material segments and the at least one second arc shaped wet friction material segment is at least two second arc shaped wet friction material segments,
the first edge of each of the least two first arc shaped wet friction material segments is circumferentially spaced apart from the second edge of one of the at least two second arc shaped wet friction material segments such that the first edge of each the least two first arc shaped wet friction material segments is spaced apart from and directly faces the second edge of one of the at least two second arc shaped wet friction material segments, and
the second edge of each of the least two first arc shaped wet friction material segments is circumferentially spaced apart from the first edge of one of the at least two second arc shaped wet friction material segments such that the second edge of each the least two first arc shaped wet friction material segments is spaced apart from and directly faces the first edge of one of the at least two second arc shaped wet friction material segments.

14. A method of making a wet friction assembly comprising:
fixing at least one first arc shaped wet friction material segment and at least one second arc shaped wet friction material segment to a part to form an annular wet friction material layer on the part,
each first arc shaped wet friction material segment having a first composition including a binder, fibers and filler particles,
each second arc shaped wet friction material segment having a second composition including a binder, fibers and filler particles,
the first composition being different from the second composition.

15. The method as recited in claim 14 wherein the first composition includes a first fiber composition of the fibers and the second composition includes a second fiber composition of the fibers, the first fiber composition being different from the second fiber composition.

16. The method as recited in claim 15 wherein the first fiber composition includes a first composition of aramid fibers and a first composition of cellulose fibers,
wherein the second fiber composition includes a second composition of aramid
fibers and a second composition of cellulose fibers, the first composition of aramid fibers being less than the second composition of aramid fibers,
the first composition of cellulose fibers being greater than the second composition of cellulose fibers.

17. The method as recited in claim 16 wherein the first composition, by weight percentage, includes 3 to 14% aramid fibers, 25 to 43% cellulose fibers, 13 to 32% filler particles and 30 to 40% binder,
wherein the second composition, by weight percentage, includes 25 to 43% aramid fibers, 3 to 14% cellulose fibers and 13 to 32% filler particles.

18. The method as recited in claim 15 wherein each of the at least one first arc shaped wet friction material segments and each of the at least one second arc shaped wet friction material segments has:
a first axially facing surface configured as a friction contacting surface configured for being brought in and out of contact with a further surface for frictional engagement with the further surface,
a first edge extending radially and facing circumferentially in a first direction,
a second edge extending radially and facing circumferentially in a second direction,
a third edge extending circumferentially from the first edge to the second edge and defining an inner circumference of the respective first or second arc shaped wet friction material segment, and
a fourth edge extending circumferentially from the first edge to the second edge and defining an outer circumference of the respective first or second arc shaped wet friction material segment;
each of the first, second, third and fourth edges joining the first axially facing surface of the respective first or second arc shaped wet friction material segment,
wherein each of the at least one first arc shaped wet friction material segments defines a first angular range of between 10 and 180 degrees between the respective first edge and the respective second edge, and each of the at least one second arc shaped wet friction material segments defines a second angular range between 10 and 180 degrees between the respective first edge and the respective second edge,
where after the fixing:
the first edge of the least one first arc shaped wet friction material segment contacts the second edge of the least one second arc shaped wet friction material segment; or
the first edge of the least one first arc shaped wet friction material segment is circumferentially spaced apart from the second edge of the least one second arc shaped wet friction material segment such that the first edge of the least one first arc shaped wet friction material segment is spaced apart from and directly faces the second edge of the least one first arc shaped wet friction material segment.
